(19) United States
(12) Patent Application Publication
(10) Pub. No.: US 2016/0002089 A1
(43) Pub. Date: Jan. 7, 2016

(54) METHOD FOR MANUFACTURING PREFORM FOR PHOTONIC BAND GAP FIBER, METHOD FOR MANUFACTURING PHOTONIC BAND GAP FIBER, PREFORM FOR PHOTONIC BAND GAP FIBER, AND PHOTONIC BAND GAP FIBER

(71) Applicants: FUJIKURA LTD., Tokyo (JP); NATIONAL UNIVERSITY CORPORATION HOKKAIDO UNIVERSITY, Sapporo-shi, Hokkaido (JP)

(72) Inventors: Shoichiro Matsuo, Sakura-shi, Chiba (JP); Kunimasa Saitoh, Sapporo-shi, Hokkaido (JP)

(73) Assignees: NATIONAL UNIVERSITY CORPORATION HOKKAIDO UNIVERSITY, Sapporo-shi, Hokkaido (JP); FUJIKURA LTD., Tokyo (JP)

(21) Appl. No.: 14/770,220

(22) PCT Filed: Feb. 25, 2014
(86) PCT No.: PCT/JP2014/054557

§ 371 Date: Aug. 25, 2015

(30) Foreign Application Priority Data
Feb. 26, 2013 (JP) 2013-036428

(51) Int. Cl. C03B 37/012; G02B 6/032; G02B 6/02; C03B 37/027

(52) U.S. Cl. CPC C03B 37/0122; C03B 37/02781; G02B 6/032; G02B 6/02347; G02B 6/02371; C03B 2203/16; C03B 2203/42

(57) ABSTRACT

A photonic band gap fiber 1 includes a hollow core region 10 and a band gap region 27 in a honeycomb shape surrounding the core region 10 and having a plurality of holes 21 formed in a glass body 22. The holes 21 are surrounded by columnar glass bodies 25 disposed on three alternate apexes of a hexagon HEX and plate glass bodies 26 disposed so as to join the columnar glass bodies 25 to the other three apexes of the hexagon HEX. The columnar glass bodies 25 are disposed in a triangular lattice shape.

### TECHNICAL FIELD

The present invention relates to a method for manufacturing a photonic band gap fiber preform, a method for manufacturing a photonic band gap fiber, a photonic band gap fiber preform, and a photonic band gap fiber that can be easily manufactured and can increase the wavelength range of light whose waves are guidable.

### BACKGROUND ART

As one of optical fibers, a photonic band gap fiber is known. The photonic band gap fiber has a structure in which a core region is surrounded by a band gap region in a cladding, and is expected as an optical fiber that can realize low loss characteristics and low nonlinear optical characteristics. The photonic band gap fiber includes a hollow core photonic band gap fiber having a core region formed of holes and a band gap region that a large number of holes are periodically disposed around the hollow core region, and includes a solid core photonic band gap fiber having a solid core region filled with a glass body and a band gap region that high refractive index glass bodies are periodically disposed around the solid core region. In these photonic band gap fibers, the hollow core photonic band gap fiber is expected as an optical fiber that can realize super low nonlinear optical characteristics and super low loss characteristics in a wavelength range of 2 μm.

In Non Patent Literature 1 below, an example of a hollow core photonic band gap fiber like this is described. In this photonic band gap fiber, a band gap region is in a honeycomb shape formed with a large number of holes, and the holes are formed in which the holes are individually surrounded by columnar glass bodies disposed on the apexes of a hexagon and a plate glass body disposed so as to join adjacent columnar glass bodies to each other. Therefore, the shapes in the cross sections of the holes are nearly in a hexagonal shape. However, strictly speaking, the shape is a shape that the apexes of a hexagon are protruded in an arc shape into the hexagon. The photonic band gap fiber as decried above is generally manufactured using a stack-and-draw method. In the manufacture processes, the photonic band gap fiber is manufactured through processes in which a band gap capillary forming a part of a band gap region is disposed in a triangular lattice shape, and a band gap rod forming the other part of the band gap region is disposed in regions surrounded by three band gap capillaries. In other words, in the state in which the band gap capillaries and the band gap rods are disposed, the band gap capillaries are individually surrounded by six band gap rods. These band gap rods are the columnar glass bodies described above, and the band gap capillaries are the plate glass bodies described above. According to Non Patent Literature 1 described below, this photonic band gap fiber has the characteristics that the wavelength range of light whose waves are guidable can be increased as compared with a photonic band gap fiber that holes are surrounded by plate glass bodies and the hole shape is in a regular hexagonal shape.

Moreover, Non Patent Literature 2 mentioned below describes another example of a hollow core photonic band gap fiber. In this photonic band gap fiber, a large number of holes are formed in a band gap region, and the holes are formed in which the holes are individually surrounded by columnar glass bodies disposed on the apexes of a triangle and plate glass bodies disposed so as to join adjacent columnar glass bodies to each other. Therefore, although the holes are in a nearly triangular shape, strictly speaking, the holes are in a shape in which the apexes of a triangle are protruded in an arc shape into the triangle. Non Patent Literature 2 mentioned below describes a calculation result that this photonic band gap fiber can more increase the wavelength range of light whose waves are guidable than the photonic band gap fiber of Non Patent Literature 1 described above does.
[Non Patent Literature 1] Optics Letters, Vol. 30, No. 15, pp. 1920-1922 (2005)
[Non Patent Literature 2] Optics Letters, Vol. 30, No. 17, pp. 2837-2839 (2010)

### SUMMARY OF INVENTION

In the photonic band gap fiber described in Non Patent Literature 2 mentioned above, the band gap region is formed of the columnar glass bodies disposed in a triangular lattice shape and the plate glass bodies joining the columnar glass bodies. However, it is very difficult to form a band gap region in this shape. In the case where a photonic band gap fiber is manufactured using at least a stack-and-draw method, it is not enabled to stably dispose band gap capillaries and band gap rods how the band gap capillaries and the band gap rods are disposed. Therefore, it is unknown whether this photonic band gap fiber can be actually manufactured.

On the other hand, in the photonic band gap fiber described in Patent Literature 1 above, in the case where the photonic band gap fiber is manufactured using a stack-and-draw method, the band gap capillaries and the band gap rods can be stably disposed, and the photonic band gap fiber can be actually manufactured. However, it is demanded to increase the wavelength range of light whose waves are guidable more than this photonic band gap fiber does.

Therefore, it is an object of the present invention to provide a method for manufacturing a photonic band gap fiber preform, a method for manufacturing a photonic band gap fiber, and a photonic band gap fiber preform that can realize a photonic band gap fiber that can be easily manufactured and can increase the wavelength range of light whose waves are guidable, and a photonic band gap fiber.

In order to achieve the object, a method for manufacturing a photonic band gap fiber preform according to the present invention is a method for manufacturing a photonic band gap fiber preform including: a preparation process in which a core capillary, a plurality of band gap capillaries, a plurality of band gap rods, and a cladding capillary are prepared; a disposition process in which the core capillary and the band gap capillaries are disposed in a hole of the cladding capillary in a manner that the plurality of the band gap capillaries is disposed in a triangular lattice shape to surround the core capillary and the band gap rods are disposed in a region surrounded by three of the band gap capillaries in a manner that the band gap capillaries are surrounded by three of the band gap rods at regular spacings; and an integration process in which a space in the hole of the cladding capillary is collapsed to integrate the cladding capillary, the plurality of the band gap capillaries, the plurality of the band gap rods, and the core capillary with one another. A photonic band gap fiber preform according to the present invention is manufactured through the processes.

Moreover, an aspect of a method for manufacturing a photonic band gap fiber according to the present invention is a method for manufacturing a photonic band gap fiber including a drawing process for drawing a photonic band gap fiber preform manufactured through the method for manufacturing a photonic band gap fiber preform. An aspect of a photonic band gap fiber according to the present invention is manufactured through the drawing process.

Alternatively, another aspect of a method for manufacturing a photonic band gap fiber according to the present invention is a method for manufacturing a photonic band gap fiber including: a preparation process in which a core capillary, a plurality of band gap capillaries, a plurality of band gap rods, and a cladding capillary are prepared; a disposition process in which the core capillary and the band gap capillaries are disposed in a hole of the cladding capillary in a manner that the plurality of the band gap capillaries is disposed in a triangular lattice shape to surround the core capillary and the band gap rods are disposed in a region surrounded by three of the band gap capillaries in a manner that the band gap capillaries are surrounded by three of the band gap rods at regular spacings; and a drawing process in which drawing is performed while collapsing a space in the hole of the cladding capillary and integrating the cladding capillary, the plurality of the band gap capillaries, the plurality of the band gap rods, and the core capillary with one another. Another aspect of a photonic band gap fiber according to the present invention is manufactured through these processes.

The present inventors dedicatedly investigated the configuration of a photonic band gap fiber that can increase the wavelength range of light whose waves are guidable more than the photonic band gap fiber described in Non Patent Literature 1 does and can be easily manufactured. Consequently, the present inventors were enabled to obtain such a result that when a columnar glass body is disposed on alternate three apexes of a hexagon surrounding a hole, a plate glass body is disposed on a line connecting the columnar glass body to the other three alternate apexes of the hexagon and thus the columnar glass bodies are disposed in a triangular lattice shape, unlike the photonic band gap fiber described in Non Patent Literature 1 in which a columnar glass body is disposed on the apexes of a hexagon surrounding a hole in a band gap region, the wavelength range of light whose waves are guidable can be increased more than the photonic band gap fiber described in Non Patent Literature 1 does. Moreover, such a conclusion was reached that with this configuration, a photonic band gap fiber can be stably manufactured using a stack-and-draw method. More specifically, in the manufacture processes of a photonic band gap fiber using a stack-and-draw method, a plurality of band gap capillaries for forming a band gap region is disposed in a triangular lattice shape, and a band gap rod is disposed in a region surrounded by three band gap capillaries. At this time, the band gap rod is disposed only one of the regions adjacent to each other, so that the band gap capillary is supported and surrounded by three band gap rods at regular spacings, and the band gap rod is supported and surrounded by three band gap capillaries at regular spacings. In this manner, the band gap capillaries and the band gap rods are supported on one another, and are stabilized. Therefore, the photonic band gap fiber can be stably manufactured using a stack-and-draw method.

Therefore, according to the photonic band gap fiber preform manufactured by the method for manufacturing a photonic band gap fiber preform as described above and the photonic band gap fiber using the same, it is possible to realize a photonic band gap fiber that can be easily manufactured and can increase the wavelength range of light whose waves are guidable, and a photonic band gap fiber manufactured by drawing the photonic band gap fiber obtained not through a preform can be a similar photonic band gap fiber as well.

Moreover, in the method for manufacturing a photonic band gap fiber preform, the photonic band gap fiber preform manufactured through the method, the method for manufacturing a photonic band gap fiber, and the photonic band gap fiber manufactured through the method, the plurality of the band gap capillaries is preferably closely packed and disposed.

A plurality of the band gap capillaries is closely packed and disposed, so that a band gap capillary is surrounded by six band gap capillaries, and the adjacent band gap capillaries are supported on each other. Therefore, in the manufacture processes of the photonic band gap fiber preform and the photonic band gap fiber, the band gap capillaries and the band gap rods can be further stabilized.

Furthermore, in the method for manufacturing a photonic band gap fiber preform, the photonic band gap fiber preform manufactured through the method, the method for manufacturing a photonic band gap fiber, and the photonic band gap fiber manufactured through the method, a radius of the band gap rod is preferably greater than a wall thickness of the band gap capillary.

In addition, still another aspect of a photonic band gap fiber according to the present invention is a photonic band gap fiber including: a hollow core region; and a band gap region in a honeycomb shape surrounding the core region and having a plurality of holes formed in a glass body. In the photonic band gap fiber, the hole of the band gap region is surrounded by a columnar glass body disposed on three alternate apexes of a hexagon and a plate glass body disposed to join the columnar glass body to other three apexes of the hexagon; and the columnar glass body is disposed in a triangular lattice shape.

A photonic band gap fiber like this can be easily manufactured as described above, and can increase the wavelength range of light whose waves are guidable more than the photonic band gap fiber mentioned in Non Patent Literature 1 does as described above.

As described above, according to the present invention, there are provided a method for manufacturing a photonic band gap fiber preform, a method for manufacturing a photonic band gap fiber, and a photonic band gap fiber preform that can realize a photonic band gap fiber that can be easily manufactured and can increase the wavelength range of light whose waves are guidable, and a photonic band gap fiber.

### BRIEF DESCRIPTION OF DRAWINGS

FIG. 1 is a diagram of the appearance of a cross section perpendicular to the longitudinal direction of a photonic band gap fiber according to an embodiment of the present invention.

FIG. 2 is an enlarged diagram of a region surrounded by a broken line in a circular shape in FIG. 1.

FIG. 3 is a diagram of the relationship between wavelengths propagated through the photonic band gap fiber and losses.

FIG. 4 is a diagram of the appearance of the band gap region of a photonic band gap fiber according to a first comparative example.

FIG. 5 is a diagram of the appearance of the band gap region of a photonic band gap fiber according to a second comparative example.

FIG. 6 is a diagram of the appearance of the band gap region of a photonic band gap fiber according to a third comparative example.

FIG. 7 is a diagram of the relationship between a ratio of the inter-center pitch of the hole of the photonic band gap fibers to the diameter of the hole and normalized bands.

FIG. 8 is a flowchart of a first example of the processes of manufacturing the photonic band gap fiber in FIG. 1.

FIG. 9 is a diagram of the appearance after a disposition process.

FIG. 10 is a cross sectional view of the appearance of a photonic band gap fiber preform after an integration process.

FIG. 11 is a diagram of a manner of a drawing process.

FIG. 12 is a flowchart of a second example of the processes of manufacturing the photonic band gap fiber in FIG. 1.

### DESCRIPTION OF EMBODIMENTS

In the following, a method for manufacturing a photonic band gap fiber preform, a method for manufacturing a photonic band gap fiber, a photonic band gap fiber preform, and a photonic band gap fiber according to the present invention will be described in detail with reference to the drawings. It is noted that for easy understanding, the scales in the drawings are sometimes different from the scales described in the following description.

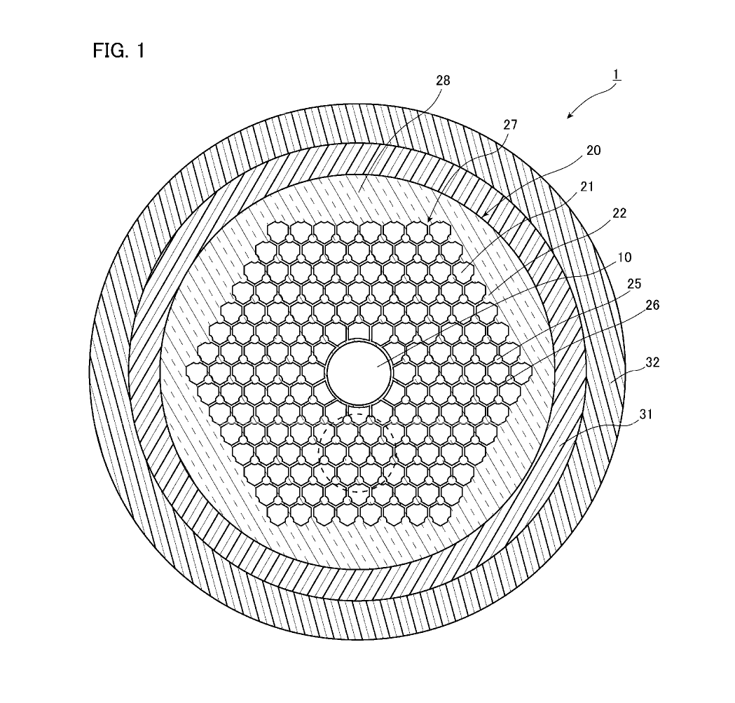

FIG. 1 is a diagram of the appearance of a cross section perpendicular to the longitudinal direction of a photonic band gap fiber according to this embodiment. As illustrated in FIG. 1, a photonic band gap fiber 1 includes a core region 10, a cladding 20 that encloses the outer circumference of the core region 10, a first buffer layer 31 that covers the cladding 20, and a second buffer layer 32 that covers the first buffer layer 31 as main components.

A hole is formed in the center of the photonic band gap fiber 1, and the hole is the core region 10.

Moreover, the cladding 20 is formed of a glass body 22. A large number of holes 21 are formed in the region surrounding the core region 10 of the cladding 20. The region in which a large number of the holes 21 are formed is a band gap region 27. No hole is formed in the region surrounding the band gap region 27, and the region is a jacket region 28.

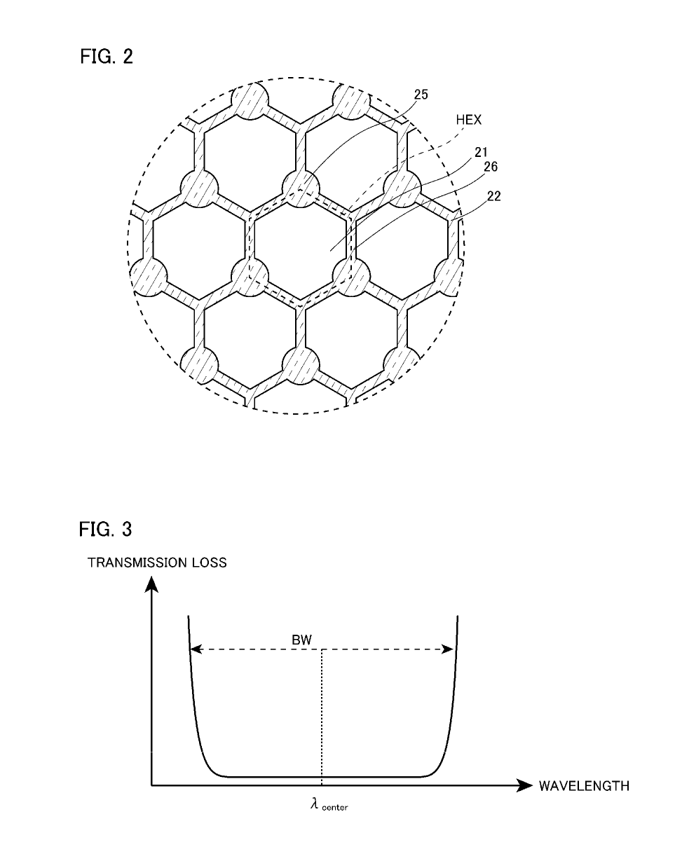

FIG. 2 is an enlarged diagram of a region surrounded by a broken line in a circular shape in FIG. 1, and is a diagram of the structure of the band gap region 27. As illustrated in FIG. 2, the hole 21 of the band gap region is surrounded by columnar glass bodies 25 and plate glass bodies 26. More specifically, the hole 21 is surrounded by the columnar glass bodies 25 disposed on three alternate apexes of a hexagon HEX depicted by a broken line in FIG. 2 and six plate glass bodies 26 disposed so as to join the columnar glass bodies 25 to the other three apexes. The diameter of the columnar glass body 25 is formed greater than the thickness of the plate glass body 26. Although the cross sectional shape is preferably in a circular shape, it may be fine that the cross sectional shape is a shape other than a circular shape. Since the plate glass bodies 26 are disposed on the edges of the hexagon HEX, the cross sectional shapes of the holes 21 are in a nearly hexagon. However, since the columnar glass bodies 25 are disposed on the alternate apexes of the hexagon HEX, strictly speaking, the cross sectional shapes of the holes 21 are in a shape in which three alternate apexes of the apexes of a hexagon are protruded in an arc shape into the inner side of the hexagon. It is noted that although the hexagon HEX is ideally in a regular hexagon, it may be fine that the hexagon HEX is a hexagon whose size of an interior angle is smaller than an angle of 180°. For example, although the most of the hexagons HEX surrounding the holes 21 in the band gap region 27 have a shape nearly in a regular hexagon, in some cases, the hexagons HEX of the holes 21 on the innermost side are partially deformed, and a part of the apexes has an angle very close to an angle of 180°.

Moreover, three plate glass bodies 26 are radially connected to the columnar glass bodies 25 individually. The columnar glass bodies 25 are disposed in a triangular lattice shape, and the periphery of the plate glass body 26 connected to the columnar glass body 25 is joined to the periphery of the plate glass body 26 connected to the other columnar glass body 25. Therefore, a single plate glass body separates two holes 21 adjacent to each other, and a single columnar glass body 25 separates three holes 21 adjacent to one another. Thus, a large number of the holes 21 whose cross sectional shape is in a nearly hexagon are formed in such a manner that the hole 21 is surrounded by six holes through the columnar glass bodies 25 and the plate glass bodies 26, and the band gap region 27 is in a honeycomb shape.

The first buffer layer 31 that covers the cladding 20 and the second buffer layer 32 that covers the first buffer layer 31 are formed of resins different from each other, for example.

In this photonic band gap fiber 1, the wavelength of light propagated through the core region 10 is determined by the pitch and the like between the holes 21 in the band gap region 27. In accordance with the photonic band gap fiber 1 according to the embodiment, the wavelength range of light propagated through the core region 10 can be increased as compared with the case where the columnar glass body 25 is not disposed and the holes are formed of only the plate glass bodies 26.

In the following, the wavelength range of light propagated through the core region of the photonic band gap fiber will be described.

FIG. 3 is a diagram of the general relationship between wavelengths propagated through the photonic band gap fiber and losses. In FIG. 3, the horizontal axis expresses wavelengths, and the vertical axis expresses optical transmission losses. As illustrated in FIG. 3, the photonic band gap fiber can propagate light in a predetermined wavelength range with very low losses. However, when the wavelength range of the light goes out of this predetermined wavelength range, the transmission loss is suddenly increased, and the photonic band gap fiber is not enabled to substantially propagate the light at these wavelengths. This predetermined wavelength range is expressed by a transmission band width BW. Here, a normalized band W can be expressed by the following expression where the center wavelength of the transmission band width BW is defined by λ_{center}.

$$W = \frac{BW}{{λ}_{center}}$$

It is known that the normalized band W is changed depending on a ratio d/Λ of a diameter d of the holes to an inter-center pitch Λ between the holes adjacent to each other through the plate glass body. Generally, the normalized band W is increased as the ratio d/Λ is increased. When the ratio d/Λ takes one, the glass body separating the holes from each other is gone, and it is not enabled to maintain the physical shape as a photonic band gap fiber. In the case where the range of the ratio d/Λ is in a range of 0.95 to 0.97, both inclusive, in a typical photonic band gap fiber, the normalized band W ranges from 10% to 20%, both inclusive. Meanwhile, the transmission band width BW takes a wavelength range of 150 to 200 nm, both inclusive, in the case where a communication wavelength range of a 1,550 nm band is covered. Therefore, an increase in the transmission band width BW can increase the wavelength range of light usable for communications as well as it is expected that this increase expands the applications of optical fibers for femto second pulse delivery and optical fibers for measurement.

The normalized band W will be described as the band gap region of the photonic band gap fiber according to the present invention is compared with band gap regions different from the present invention.

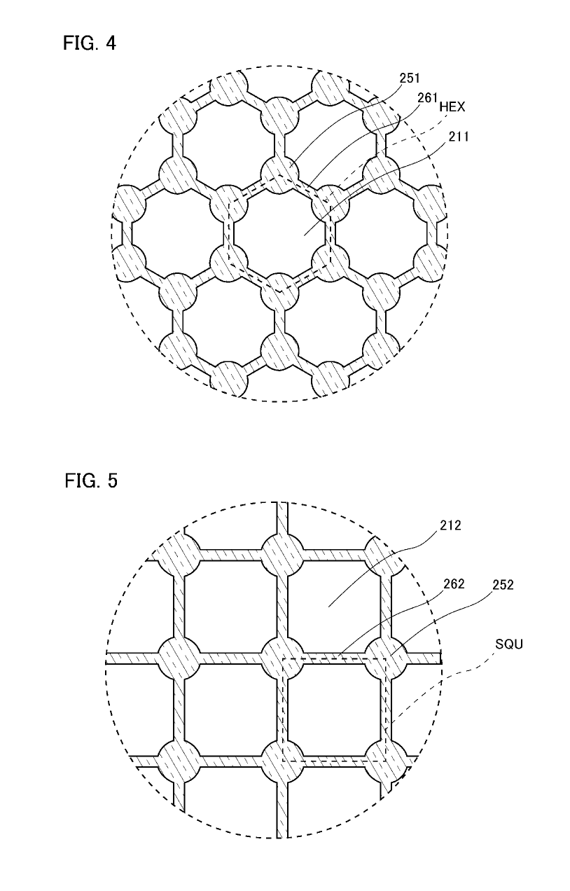

FIG. 4 is a diagram of the appearance of a band gap region of a first comparative example different from the band gap region 27 of the photonic band gap fiber 1 according to the present invention. In the band gap region illustrated in FIG. 4, the shapes of holes 211 and the shape of a glass body separating the adjacent holes from each other are different from the shapes of the holes 21 of the band gap region 27 and the shape of the glass body 22 of the photonic band gap fiber 1. More specifically, in the band gap region according to the first comparative example, the hole 211 is surrounded by cylindrical columnar glass bodies 251 disposed on the adjacent apexes of a hexagon HEX depicted by a broken line and six plate glass bodies 261 disposed so as to join the adjacent columnar glass bodies 251 to each other and having a thickness smaller than the diameter of the columnar glass body 251. Therefore, the cross sectional shapes of the holes 211 are in a shape in which the apexes of a hexagon are protruded in an arc shape into the inner side of the hexagon. It is noted that in this example, the case is described where the hexagon HEX is a regular hexagon.

FIG. 5 is a diagram of the appearance of a band gap region of a second comparative example different from the band gap region 27 of the photonic band gap fiber 1 according to the present invention. Also in the band gap region illustrated in FIG. 5, the shapes of holes 212 and the shape of a glass body separating the adjacent holes from each other are different from the shapes of the holes 21 of the band gap region 27 and the shape of the glass body 22 of the photonic band gap fiber 1. More specifically, the hole 212 is surrounded by four columnar glass bodies 252 disposed on the apexes of a quadrilateral SQU depicted by a broken line in FIG. 5 and four plate glass bodies 262 disposed so as to join the adjacent columnar glass bodies 252 to each other and having a thickness smaller than the diameter of the columnar glass body 252. With this configuration, the cross sectional shapes of the holes 212 are in a shape in which the apexes of a quadrilateral are protruded in an arc shape into the inner side of the quadrilateral. It is noted that in this example, the case is described where the quadrilateral SQU is a square.

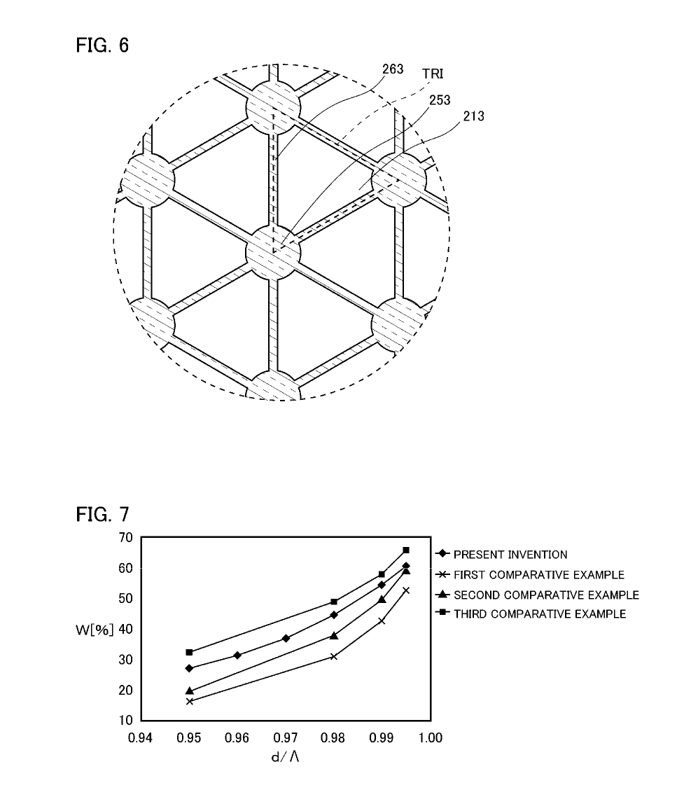

FIG. 6 is a diagram of the appearance of a band gap region of a third comparative example different from the band gap region 27 of the photonic band gap fiber 1 according to the present invention. Also in the band gap region illustrated in FIG. 6, the shapes of holes 213 and the shape of a glass body separating the adjacent holes from each other are different from the shapes of the holes 21 of the band gap region 27 and the shape of the glass body 22 of the photonic band gap fiber 1. More specifically, the hole 213 is surrounded by cylindrical columnar glass bodies 253 disposed on the apexes of a triangle TRI depicted by a broken line in FIG. 6 and three plate glass bodies 263 disposed so as to join the adjacent columnar glass bodies 253 to each other and having a thickness smaller than the diameter of the columnar glass body 253. With this configuration, the cross sectional shapes of the holes 213 are in a shape in which the apexes of a triangle are protruded in an arc shape into the inner side of the triangle. It is noted that in this example, the case is described where the triangle TRI is a right triangle.

FIG. 7 is a diagram of the relationship between the ratio of the inter-center pitch of the holes adjacent to each other to the diameter of the holes and the normalized band by simulation on the photonic band gap fiber 1 having the band gap region 27 in FIG. 2 and the photonic band gap fibers having the band gap regions in FIGS. 4 to 6. It is noted that in the description of this drawing, in the photonic band gap fibers, although the configurations in the inside of the band gap region are different from one another as described above, the configurations other than the configurations in the inside of the band gap region such as the size of the band gap region are the same among the photonic band gap fibers.

Moreover, in the simulation of the photonic band gap fiber according to the embodiment, the hexagon HEX illustrated in FIG. 2 is a regular hexagon, and the diameter d of the hole 21 is the length of a line connecting the inner walls of the plate glass bodies 26 disposed on the opposite edges to each other. Furthermore, a diameter 2r of the columnar glass body 25 is the diameter of the inscribed circle of the columnar glass body. In addition, the diameter d of the hole 211 illustrated in FIG. 4 is the length of a line connecting the inner walls of the plate glass bodies 261 disposed on the opposite edges to each other. Moreover, the diameter d of the hole 212 illustrated in FIG. 5 is the length of a line connecting the inner walls of the plate glass bodies 262 disposed on the opposite edges to each other, and the diameter 2r of the columnar glass body 252 is the diameter of the inscribed circle of the columnar glass body. Furthermore, the diameter d of the hole 213 illustrated in FIG. 6 is the length of a line connecting the inner wall of the columnar glass body 253 disposed on a single apex of the triangle TRI to the inner wall of the plate glass body 263 disposed on the opposite edge of the apex. The diameter 2r of the columnar glass body 253 is the diameter of the inscribed circle of the columnar glass body.

As illustrated in FIG. 7, according to the simulation conducted by the present inventors, it is revealed that in any of the photonic band gap fibers, the normalized band W is increased as the ratio d/Λ comes close to one. Moreover, on the normalized band W, the photonic band gap fiber having the band gap region according to the third comparative example exhibited the largest value, the photonic band gap fiber according to the present invention exhibited the second largest value, the photonic band gap fiber having the band gap region according to the second comparative example exhibited a large value, and the photonic band gap fiber having the band gap region according to the first comparative example exhibited the smallest normalized band W. In the case where optical center wavelengths are the same, the transmission band width BW and the normalized band W are in a linear relationship, and such a result was shown that the photonic band gap fiber according to the present invention had the second largest transmission band width BW next to the third comparative example. However, it is difficult to manufacture the photonic band gap fiber having the band gap region according to the third comparative example. It is noted that more specifically, Patent Literature 1 mentioned above describes that although not illustrated in the drawing, even the photonic band gap fiber according to the first comparative example can increase the wavelength range of light propagated through the core region as compared with the case where the columnar glass body is not disposed, the holes are surrounded by only six plate glass bodies, and the holes are formed in a regular hexagonal shape. Thus, in the photonic band gap fibers that can be generally manufactured, the photonic band gap fiber according to the present invention shows a result that the wavelength range of light whose waves are guidable can be increased.

Here, a table below is the relationship among the ratio d/Λ, the normalized band W, the normalized columnar glass body radius r/Λ, and the transmission band width BW of the photonic band gap fiber 1 according to the present invention. It is noted that r defines the radius of the columnar glass body. The normalized columnar glass body radius r/Λ expresses a value that the radius of the columnar glass body is divided by the inter-center pitch A of the holes. The normalized frequency expresses a value at a wavelength of 1,550 nm. As shown in the table below, in accordance with the photonic band gap fiber 1 according to the present invention, it is possible to realize the transmission band width BW exceeding 400 nm even in the case where the ratio d/Λ is 0.95, and it is possible to realize the transmission band width BW exceeding 850 nm when the ratio d/Λ can be increased to 0.99.

TABLE 1

| d/ [symbol] | W(%) | r/ [symbol] | BW(nm) |
|---|---|---|---|
| 0.95 | 27.2 | 0.21 | 422 |
| 0.96 | 31.6 | 0.20 | 490 |
| 0.97 | 37.1 | 0.18 | 575 |
| 0.98 | 44.8 | 0.15 | 694 |
| 0.99 | 54.8 | 0.13 | 850 |
| 0.995 | 61.1 | 0.08 | 947 |

Next, a method for manufacturing the photonic band gap fiber 1 will be described.

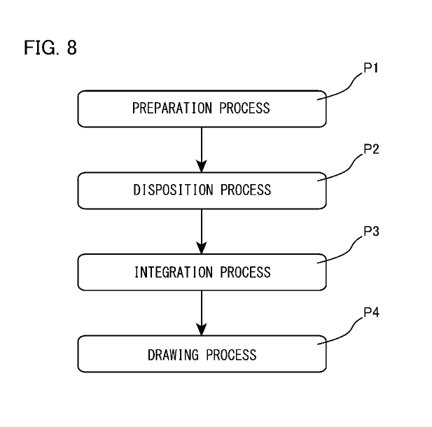

FIG. 8 is a flowchart of a first example of the processes of manufacturing the photonic band gap fiber in FIG. 1. As illustrated in FIG. 8, a method for manufacturing the photonic band gap fiber 1 includes a preparation process P1, a disposition process P2, an integration process P3, and a drawing process P4, and a photonic band gap fiber preform is manufactured through the preparation process P1, the disposition process P2, and the integration process P3.

<Preparation Process P1>

First, a core capillary, a plurality of band gap capillaries, a plurality of band gap rods, and a cladding capillary are prepared.

The core capillary is formed of a glass body, and in a cylindrical shape. Moreover, a plurality of the band gap capillaries is formed of a glass body, and in a cylindrical shape having the same wall thickness. The band gap capillaries are prepared in the same number as the number of the holes 21 of the photonic band gap fiber 1 in FIG. 1, and the number is a number that the core capillary can be surrounded in layers. Furthermore, in the embodiment, the inner diameter of the band gap capillary is set smaller than the inner diameter of the core capillary, and the outer diameter of the band gap capillary is set smaller than the outer diameter of the core capillary. In addition, a plurality of the band gap rods is individually formed of a glass body, and in a cylindrical shape. The band gap rods are prepared in the number that the band gap rods can be disposed between the band gap capillaries as necessary. Moreover, the cladding capillary is formed of a glass body, has an inner diameter that the core capillary, the band gap capillaries, and the band gap rods can be organized and disposed on the through hole, and has a predetermined wall thickness.

<Disposition Process P2>

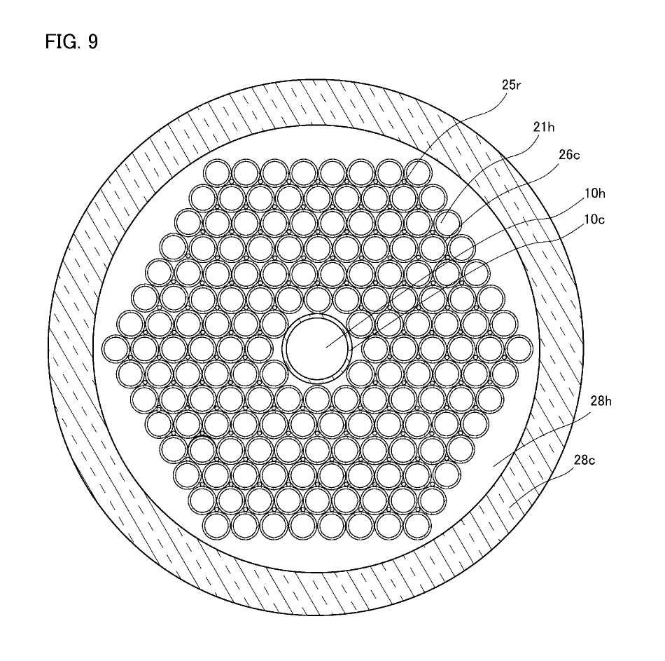

Next, the core capillary, a plurality of the band gap capillaries, and a plurality of the band gap rods are disposed in the through hole of the cladding capillary. FIG. 9 is a diagram of the appearance after this process.

As illustrated in FIG. 9, in the process, a core capillary 10c is disposed in the center of the inside of a through hole 28h of a cladding capillary 28c, and a plurality of band gap capillaries 26c is disposed in a triangular lattice shape to surround the core capillary 10c. It is noted that in the embodiment, the band gap capillaries 26c are closest packed and disposed. Moreover, band gap rods 25r are individually disposed in a region surrounded by three band gap capillaries 26c in such a manner that the band gap capillaries 26c are individually surrounded by three band gap rods 25r at regular spacings. In other words, a region surrounded by three band gap capillaries 26c are provided at six places around the individual band gap capillaries 26c, and the band gap rod 25r is disposed one by one in these three alternate regions. Such a state is provided in which the core capillary 10c, a plurality of the band gap capillaries 26c, and a plurality of the band gap rods 25r are disposed in the inside of the through hole 28h of the cladding capillary 28c.

In this state, the band gap capillaries 26c are individually supported on three band gap rods 25r, and the motion is limited. The band gap rods 25r are individually supported on three band gap capillaries 26c, and the motion is limited. More specifically, in the embodiment, since the band gap capillaries 26c are closely packed and disposed as described above, the adjacent band gap capillaries 26c are supported on each other, and the motion of the band gap capillaries 26c is further limited. Since the motion of the band gap capillaries 26c and the motion of the band gap rods 25c are limited in this manner, the motion of the core capillary is also limited. As a result, the core capillary 10c, the band gap capillaries 26c, and the band gap rods 25c are stabilized.

It is noted that although not illustrated in the drawing specifically, it may be fine that another glass rod is disposed in a space other than a space between the band gap capillaries 26c, such as a space between the cladding capillary 28c and the band gap capillary 26c and a space between the core capillary 10c and the band gap capillary 26c.

<Integration Process P3>

Next, the space in the inside of the through hole 28h of the cladding capillary 28c is collapsed, and the cladding capillary 28c, a plurality of the band gap capillaries 26c, a plurality of the band gap rods 25r, and the core capillary 10c are integrated with one another. In the process, in order not to collapse the holes of the band gap capillaries 26c and the hole of the core capillary 10c, a predetermined pressure is applied to the holes of the band gap capillaries 26c and the hole of the core capillary 10c, and spaces other than the holes are vacuumed. The entire cladding capillary 28c is then heated, and the space in the inside of the through hole 28h is collapsed.

In this collapsing, the hole 10h of the core capillary 10c is turned into a hollow core region 10p of a photonic band gap fiber preform 1P corresponding to the core region 10 of the photonic band gap fiber 1. Moreover, the core capillary 10c forms the region on the innermost side of a cladding 20p of the photonic band gap fiber preform 1P corresponding to the region on the innermost side of the cladding 20 of the photonic band gap fiber 1. Furthermore, a part of the band gap capillary 26c is turned into a plate glass body 26p of the photonic band gap fiber preform 1P corresponding to the plate glass body 26 of the photonic band gap fiber 1, and the other part is turned into a part of the outer circumferential side of a columnar glass body 25p of the photonic band gap fiber preform 1P corresponding to a part of the outer circumferential side of the columnar glass body 25 of the photonic band gap fiber 1. In addition, the band gap rod 25r is turned into a part of the center side of the columnar glass body 25p of the photonic band gap fiber preform 1P corresponding to a part of the center side of the columnar glass body 25 of the photonic band gap fiber 1. In other words, the columnar glass body 25p of the photonic band gap fiber preform 1P corresponding to the columnar glass body 25 of the photonic band gap fiber 1 is configured of a part of the band gap rod 25r and a part of the band gap capillary 26c. The space in the inside of the through hole 28h of the cladding capillary 28c is then collapsed, a plurality of the band gap capillaries 26c disposed in a triangular lattice shape is deformed, holes 21h of the band gap capillaries 26c have a shape in which three alternate apexes of the apexes of a hexagon are protruded in an arc shape into the inner side of the hexagon, and the holes 21h are turned into holes 21p of the photonic band gap fiber preform 1P corresponding to the holes 21 of the photonic band gap fiber 1. Thus, a band gap region 27p of the photonic band gap fiber preform 1P is formed, which corresponds to the band gap region 27 of the photonic band gap fiber 1. Moreover, the cladding capillary 28c is turned into a jacket region 28p of the photonic band gap fiber preform 1P corresponding to the jacket region 28 of the photonic band gap fiber 1.

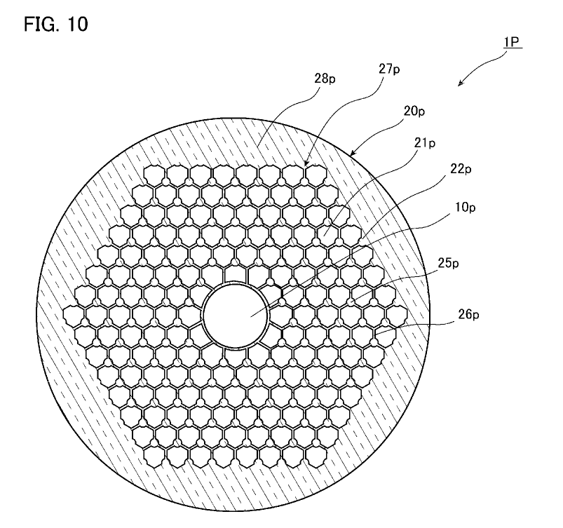

In this manner, as illustrated in FIG. 10, the photonic band gap fiber preform 1P is manufactured in the cross sectional shape analog to the shape of the region formed of the core region 10p and the cladding 20 of the photonic band gap fiber 1.

<Drawing Process P4>

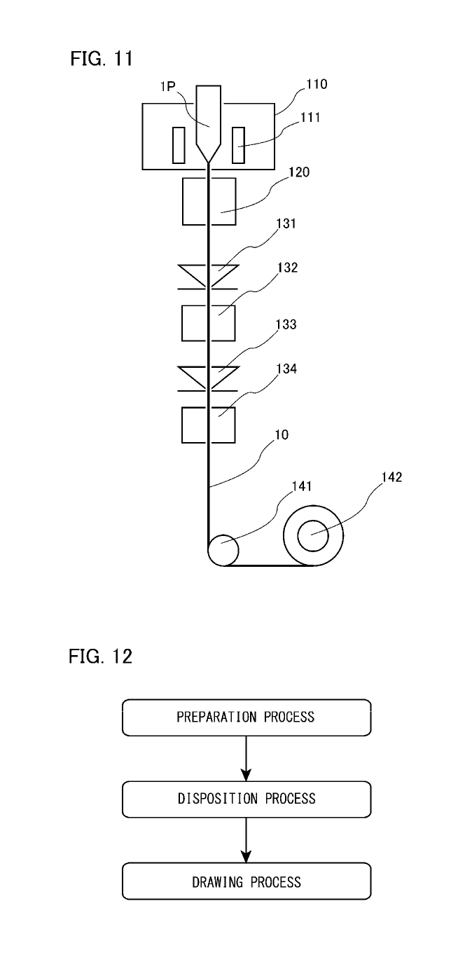

FIG. 11 is a diagram of the appearance of the drawing process P4.

First, as a preparation step for performing the drawing process P4, the photonic band gap fiber preform 1P manufactured through the preparation process P1 to the integration process P3 is disposed on a pulling furnace 110. Heat is then produced from a heating unit 111 of the pulling furnace 110 to heat the photonic band gap fiber preform 1P while applying a predetermined pressure to the hollow core region 10p and the holes 21p of the photonic band gap fiber preform 1P. In this heating, the lower end of the photonic band gap fiber preform 1P is heated at a temperature of 2,000° C., for example, and in a molten state. Glass is then melted from the photonic band gap fiber preform 1P, and glass is drawn. The drawn glass in the molten state is solidified soon after coming out of the pulling furnace 110, the hollow core region 10p of the photonic band gap fiber preform 1P is turned into the core region 10 of the photonic band gap fiber, the band gap region 27p of the photonic band gap fiber preform 1P is turned into the band gap region 27 of the photonic band gap fiber 1, and the jacket region 28p of the photonic band gap fiber preform 1P is turned into the jacket region 28 of the photonic band gap fiber 1. In this manner, a photonic band gap fiber is formed in the state in which the photonic band gap fiber is not covered with the first buffer layer 31 and the second buffer layer 32. After that, this photonic band gap fiber is passed through a cooling device 120, and is cooled to an appropriate temperature. When the photonic band gap fiber is entered to the cooling device 120, the temperature of the photonic band gap fiber is about a temperature of 1,800° C., for example, and when the photonic band gap fiber comes out of the cooling device 120, the temperature of the photonic band gap fiber is reached at temperatures from 40 to 50° C., for example.

Subsequently, the photonic band gap fiber is passed through a coating device 131 containing an ultraviolet curable resin to be the first buffer layer 31, and covered with this ultraviolet curable resin. The photonic band gap fiber is further passed through an ultraviolet application device 132, ultraviolet rays are applied to cure the ultraviolet curable resin, and the first buffer layer 31 is formed. Subsequently, the photonic band gap fiber covered with the first buffer layer 31 is passed through a coating device 133 containing an ultraviolet curable resin to be the second buffer layer 32, and covered with this ultraviolet curable resin. The photonic band gap fiber is further passed through an ultraviolet application device 134, ultraviolet rays are applied to cure the ultraviolet curable resin, the second buffer layer 32 is formed, and the photonic band gap fiber 1 illustrated in FIG. 1 is formed.

The direction of the photonic band gap fiber 1 is then changed by a turn pulley 141, and the photonic band gap fiber 1 is wound on a reel 142.

In the method for manufacturing the photonic band gap fiber preform 1P and the method for manufacturing the photonic band gap fiber 1 according to the embodiment, a photonic band gap fiber can be stably manufactured using a stack-and-draw method. More specifically, in the manufacture processes, a plurality of the band gap capillaries 26c disposed to form the band gap region 27p of the photonic band gap fiber preform 1P is supported as the band gap capillaries 26c are surrounded by three band gap rods 25r, and the band gap rod 25r is supported as the band gap rod 25r is surrounded by three band gap capillaries 26c. In this manner, the band gap capillaries 26c and the band gap rods 25r are supported on each other and stabilized. Therefore, the photonic band gap fiber can be stably manufactured using a stack-and-draw method. Thus, according to the manufacturing method as described above, it is possible to easily manufacture the photonic band gap fiber 1 that can increase the wavelength range of light whose waves are guidable.

Next, another method for manufacturing the photonic band gap fiber 1 will be described.

FIG. 12 is a flowchart of a second example of the processes of manufacturing the photonic band gap fiber in FIG. 1. As illustrated in FIG. 12, a method for manufacturing the photonic band gap fiber 1 according to this example is different from the method for manufacturing the photonic band gap fiber 1 described above in that the integration process is not included and the photonic band gap fiber preform 1P is not manufactured.

First, similarly to the method for manufacturing the photonic band gap fiber 1 described above, the preparation process P1 and the disposition process P2 are performed. Subsequently, as illustrated in FIG. 9, the drawing process is performed in the state in which the core capillary 10c, a plurality of the band gap capillaries 26c, and a plurality of the band gap rods 25r are disposed in the through hole 28h of the cladding capillary 28c.

In this example, in a preparation step for performing the drawing process, jigs are mounted on the inside of the through hole 28h and the cladding capillary 28c so as not to displace the core capillary 10c, a plurality of the band gap capillaries 26c, and a plurality of the band gap rods 25r. The core capillary 10c, a plurality of the band gap capillaries 26c, and a plurality of the band gap rods 25r in the inside of the through hole 28h and the cladding capillary 28c mounted with the jigs are then disposed on the pulling furnace 110 illustrated in FIG. 11. At this time, in this example, in order not to collapse the holes of the band gap capillaries 26c and the hole of the core capillary 10c, a predetermined pressure is applied to the holes of the band gap capillaries 26c and the hole of the core capillary 10c, and spaces other than the holes are vacuumed. Heat is then produced from the heating unit 111 of the pulling furnace 110, and the core capillary 10c, a plurality of the band gap capillaries 26c, and a plurality of the band gap rods 25r in the inside of the through hole 28h of the cladding capillary 28c are heated. Glass is then drawn while collapsing the space in the inside of the through hole 28h, the drawn glass in the molten state is solidified soon after coming out of the pulling furnace 110, and a photonic band gap fiber is provided in the state in which the photonic band gap fiber is not covered with the first buffer layer 31 and the second buffer layer 32. In other words in this example, the integration process P3 and the drawing process P4 in the first example are performed at the same time.

In this processing, the hole of the core capillary 10c is turned into the core region 10 of the photonic band gap fiber, the core capillary 10c is turned into the region on the innermost side of the cladding 20 of the photonic band gap fiber, a part of the band gap capillary 26c is turned into the plate glass body 26 of the photonic band gap fiber, the other part is turned into a part of the outer circumferential side of the columnar glass body 25 of the photonic band gap fiber, the band gap rod 25r is turned into a part of the center side of the columnar glass body of the photonic band gap fiber, and the cladding capillary 18c is turned into the jacket region 28 of the photonic band gap fiber.

After that, the photonic band gap fiber is covered with the first buffer layer 31 and the second buffer layer 32 similarly to the first example, and the photonic band gap fiber 1 is wound on the reel 142 similarly to the first example.

Also according to the method for manufacturing the photonic band gap fiber 1 in this example, the disposition process is performed similarly to the first example, so that it is possible to easily manufacture the photonic band gap fiber 1 that can increase the wavelength range of light whose waves are guidable.

As described above, the present invention is described as the embodiment is taken as an example. However, the present invention is not limited to the embodiment.

For example, in the disposition process P2 of the method for manufacturing the photonic band gap fiber 1 according to the embodiment, the band gap capillaries 26 are closely packed and disposed. However, the present invention is not limited to this configuration. It may be fine that the band gap capillaries 26 are disposed in a triangular lattice shape in the state in which a space is provided between the band gap capillaries 26 adjacent to each other. In this case, the band gap rod 25r can be thickened, and a thick columnar glass body 25 can be formed as compared with the case where the band gap capillary 26 are closely packed and disposed.

As described above, according to the present invention, there are provided a method for manufacturing a photonic band gap fiber preform, a method for manufacturing a photonic band gap fiber, and a photonic band gap fiber preform that can realize a photonic band gap fiber that can be easily manufactured and can increase the wavelength range of light whose waves are guidable, and a photonic band gap fiber, and the use in technical fields such as optical communications is expected.

### REFERENCE SIGNS LIST

1 . . . photonic band gap fiber
1P . . . photonic band gap fiber preform
10 . . . core region of the photonic band gap fiber
10p . . . core region of the photonic band gap fiber preform
10c . . . core capillary
18c . . . cladding capillary
20 . . . cladding of the photonic band gap fiber
20p . . . cladding of the photonic band gap fiber preform
21 . . . hole of the photonic band gap fiber
21p . . . hole of the photonic band gap fiber preform
22 . . . glass body
25 . . . columnar glass body of the photonic band gap fiber
25p . . . columnar glass body of the photonic band gap fiber preform
25r . . . band gap rod
26 . . . plate glass body of the photonic band gap fiber
26c . . . band gap capillary
26p . . . plate glass body of the photonic band gap fiber preform
27 . . . band gap region of the photonic band gap fiber
27p . . . band gap region of the photonic band gap fiber preform
28 . . . jacket region of the photonic band gap fiber
28h . . . through hole
28c . . . cladding capillary
28p . . . jacket region of the photonic band gap fiber preform
31 . . . first buffer layer
32 . . . second buffer layer
110 . . . pulling furnace
111 . . . heating unit
120 . . . cooling device
131 . . . coating device
132 . . . ultraviolet application device
133 . . . coating device
134 . . . ultraviolet application device
141 . . . turn pulley
142 . . . reel
HEX . . . hexagon
P1 . . . preparation process
P1 . . . preparation process
P2 . . . disposition process
P3 . . . integration process
P4 . . . drawing process

1. A method for manufacturing a photonic band gap fiber preform comprising:
a preparation process wherein a core capillary, a plurality of band gap capillaries, a plurality of band gap rods, and a cladding capillary are prepared;
a disposition process wherein the core capillary and the band gap capillaries are disposed in a hole of the cladding capillary in a manner that the plurality of the band gap capillaries is disposed in a triangular lattice shape to surround the core capillary and the band gap rods are disposed in a region surrounded by three of the band gap capillaries in a manner that the band gap capillaries are surrounded by three of the band gap rods at regular spacings; and
an integration process wherein a space in the hole of the cladding capillary is collapsed to integrate the cladding capillary, the plurality of the band gap capillaries, the plurality of the band gap rods, and the core capillary with one another.

2. The method for manufacturing a photonic band gap fiber preform according to claim 1, wherein the plurality of the band gap capillaries is closely packed and disposed.

3. The method for manufacturing a photonic band gap fiber preform according to claim 1, wherein a radius of the band gap rod is greater than a wall thickness of the band gap capillary.

4. A method for manufacturing a photonic band gap fiber comprising a drawing process for drawing a photonic band gap fiber preform manufactured through the method for manufacturing a photonic band gap fiber preform according to claim 1.

5. A method for manufacturing a photonic band gap fiber comprising:
a preparation process wherein a core capillary, a plurality of band gap capillaries, a plurality of band gap rods, and a cladding capillary are prepared;
a disposition process wherein the core capillary and the band gap capillaries are disposed in a hole of the cladding capillary in a manner that the plurality of the band gap capillaries is disposed in a triangular lattice shape to surround the core capillary and the band gap rods are disposed in a region surrounded by three of the band gap capillaries in a manner that the band gap capillaries are surrounded by three of the band gap rods at regular spacings; and
a drawing process wherein drawing is performed while collapsing a space in the hole of the cladding capillary and integrating the cladding capillary, the plurality of the band gap capillaries, the plurality of the band gap rods, and the core capillary with one another.

6. The method for manufacturing a photonic band gap fiber according to claim 5, wherein the plurality of the band gap capillaries is closely packed and disposed.

7. The method for manufacturing a photonic band gap fiber according to claim 5, wherein a radius of the band gap rod is greater than a wall thickness of the band gap capillary.

8. A photonic band gap fiber preform that is manufactured through:
a preparation process wherein a core capillary, a plurality of band gap capillaries, a plurality of band gap rods, and a cladding capillary are prepared;
a disposition process wherein the core capillary and the band gap capillaries are disposed in a hole of the cladding capillary in a manner that the plurality of the band gap capillaries is disposed in a triangular lattice shape to surround the core capillary and the band gap rods are disposed in a region surrounded by three of the band gap capillaries in a manner that the band gap capillaries are surrounded by three of the band gap rods at regular spacings; and
an integration process wherein a space in the hole of the cladding capillary is collapsed to integrate the cladding capillary, the plurality of the band gap capillaries, the plurality of the band gap rods, and the core capillary with one another.

9. The photonic band gap fiber preform according to claim 8, wherein the plurality of the band gap capillaries is closely packed and disposed.

10. The photonic band gap fiber preform according to claim 8, wherein a radius of the band gap rod is greater than a wall thickness of the band gap capillary.

11. A photonic band gap fiber that is manufactured through a drawing process for drawing a photonic band gap fiber preform according to claim 8.

12. A photonic band gap fiber that is manufactured through:
a preparation process wherein a core capillary, a plurality of band gap capillaries, a plurality of band gap rods, and a cladding capillary are prepared;
a disposition process wherein the core capillary and the band gap capillaries are disposed in a hole of the cladding capillary in a manner that the plurality of the band gap capillaries is disposed in a triangular lattice shape to surround the core capillary and the band gap rods are disposed in a region surrounded by three of the band gap capillaries in a manner that the band gap capillaries are surrounded by three of the band gap rods at regular spacings; and
a drawing process wherein drawing is performed while collapsing a space in the hole of the cladding capillary and integrating the cladding capillary, the plurality of the band gap capillaries, the plurality of the band gap rods, and the core capillary with one another.

13. The photonic band gap fiber according to claim 12, wherein the plurality of the band gap capillaries is closely packed and disposed.

14. The photonic band gap fiber according to claim 12, wherein a radius of the band gap rod is greater than a wall thickness of the band gap capillary.

15. A photonic band gap fiber comprising:
a hollow core region; and
a band gap region in a honeycomb shape surrounding the core region and having a plurality of holes formed in a glass body, wherein
the hole of the band gap region is surrounded by a columnar glass body disposed on three alternate apexes of a hexagon and a plate glass body disposed to join the columnar glass body to other three apexes of the hexagon, and
the columnar glass body is disposed in a triangular lattice shape.
